(19) United States
(12) Patent Application Publication
(10) Pub. No.: US 2023/0418272 A1
(43) Pub. Date: Dec. 28, 2023

(54) System for Determining Operating Points in a Chemical Plant

(71) Applicant: BASF SE, Ludwigshafen (DE)

(72) Inventor: Robert Pack, Ludwigshafen (DE)

(21) Appl. No.: 18/035,360

(22) PCT Filed: Nov. 8, 2021
(86) PCT No.: PCT/EP2021/080986

§ 371 Date: May 4, 2023

(30) Foreign Application Priority Data
Nov. 6, 2020 (EP) 20206291.5

(51) Int. Cl. G05B 19/418

(52) U.S. Cl. CPC G05B 19/41875

(57) ABSTRACT

A computer implemented method for determining operating states of a chemical plant, in particular of operating states in a process group, the method comprising the steps of providing signal time series data associated with a first measurement point in a chemical plant, determining based on the signal time series data associated with the first measurement point in a chemical plant a respective signal time series score associated with a measure of a degree of variation of the signal time series data over time, determining the operating state based on the respective signal time series score associated with a measure of a degree of variation of the signal time series data over time providing data associated with the operating state of the chemical plant, suitable for monitoring and/or controlling the chemical plant.

### FIELD OF THE INVENTION

The disclosure relates to a system, a computer implemented method and a computer program element for determining operating conditions in a chemical plant. The disclosure further relates to a system, a computer implemented method and a computer program element for controlling and/monitoring a chemical plant. The disclosure further relates to a method a system and a computer program element for annotating signal time series in a chemical plant.

### BACKGROUND

In chemical production industries huge amounts of measurement points are distributed over a plant. Most of these measurement points generate signal time series data. These signal time series data often contain valuable information on the operating status of the plant. Therefore, these signal time series are often stored as historical data. In principle this allows retrospective analysis of the signal time series data. This retrospective analysis of the signal time series data is tedious. Data without context carries not much information, hence the signal time series data needs to be contextualized for further evaluation. This can be done manually. However, when dealing with huge amounts of data, only a small fraction can typically be manually contextualized. Therefore, there is a need for contextualizing signal time series data in chemical industries.

### DESCRIPTION

Disclosed is in a first aspect a computer implemented method for determining operating states of a chemical plant, in particular of operating states in a process group, the method comprising the steps of:
providing signal time series data associated with a first measurement point in a chemical plant,
determining based on the signal time series data associated with the first measurement point in a chemical plant a respective signal time series score associated with a measure of a degree of variation of the signal time series data over time,
determining the operating state based on respective signal time series score associated with a measure of a degree of variation of the signal time series data over time
providing data associated with the operating state of the chemical plant, suitable for monitoring and/or controlling the chemical plant.

In another aspect a system for determining operating states of a chemical plant is disclosed, the system comprising
a time series acquisition unit for configured to receive signal time series data associated with a first measurement point in a chemical plant,
an on/off score unit configured to determine based on the signal time series data associated with the first measurement point in a chemical plant a respective signal time series score associated with a measure of a degree of variation of the signal time series data over time
an operating state determining unit configured to determine the operating state based on respective signal time series score associated with a measure of a degree of variation of the signal time series data over time and an output unit configured to provide data associated with the operating state of the chemical plant, suitable for monitoring and/or controlling the chemical plant.

In another aspect a computer program product for determining operating states of a chemical plant is disclosed, the computer program product comprising instructions, which, when executed on computing devices of a computing environment, is configured to carry out the steps of the method of determining the operating states of a chemical plant.

In another aspect a non-transitory computer readable storage medium is disclosed, the computer-readable storage medium including instructions that when executed by a computer, cause the computer to perform the steps of the method of determining the operating states of a chemical plant.

In another aspect a method for monitoring and/or controlling a chemical plant is proposed, the method comprising the steps of receiving data associated with the operating state of the chemical plant, suitable for monitoring and/or controlling the chemical plant and providing a control signal based on the received data, in particular when the received data is indicative of an instable operation state.

In another aspect a system for monitoring and/or controlling a chemical plant is disclosed, the system comprising an input interface for receiving the data associated with the operating state of the chemical plant and an output interface for providing a control signal based on the received data, in particular when the received data is indicative of an instable operation state.

In another aspect a computer program product for monitoring and/or controlling a chemical plant is disclosed, the computer program product comprising instructions, which, when executed on computing devices of a computing environment, is configured to carry out the steps of the method of monitoring and/or controlling the chemical plant.

In another aspect a non-transitory computer readable storage medium is disclosed, the computer-readable storage medium including instructions that when executed by a computer, cause the computer to perform the steps of the method of monitoring and/or controlling the chemical plant.

In another aspect a computer implemented method for annotating signal time series data associated with a first measurement point in a chemical plant, comprising the steps of receiving data associated with the operating state of the chemical plant, suitable for monitoring and/or controlling the chemical plant as generated according to the method for determining operating states of a chemical plant and storing the data associated with the operating state of the plant together with the signal time series data is disclosed.

In another aspect a system for annotating signal time series is disclosed, the system comprising a receiving unit configured to receive signal time series data associated with a first measurement point in a chemical plant, and receiving data associated with the operating state of the chemical plant, suitable for monitoring and/or controlling the chemical plant, a storage unit configured to store the signal time series data associated with a first measurement point in a chemical plant with the data associated with the operating state of the chemical plant, suitable for monitoring and/or controlling the chemical plant.

In another aspect a computer program product for annotating signal time series is disclosed, the computer program product comprising instructions, which, when executed on computing devices of a computing environment, is configured to carry out the steps of annotating signal time series data.

In another aspect a non-transitory computer readable storage medium is disclosed, the computer-readable storage medium including instructions that when executed by a computer, cause the computer to perform the steps of the method of steps of annotating signal time series data.

Disclosed is in an aspect a computer implemented method for contextualizing signal time series in a chemical production plant comprising the steps:
with a processing device
   receiving signal time series per each of at least one measurement point in the chemical production plant, optionally
   providing respective plant measurement point information for each of the least one measurement point,
   determining at least one respective signal time series score for each of the signal time series per each of at least one measurement point based on stochastically properties of the signal time series,
   generating annotated signal time series, comprising
      the signal time series per each of at least one measurement point in the chemical production plant,
      the determined at least one respective signal time series score for each of the one signal time series per each of at least one measurement point,
      the respective plant measurement point information for each of the at least one measurement point,
   clustering in clusters the annotated signal time series based on the at least one determined respective signal time series score and a respective cluster classifier,
   attributing operation states to the signal time series based on the clustering,
   providing a contextualized signal time series comprising
      the one signal time series per each of one or more measurement points,
      the determined least one respective signal time series score for each of the least one measurement points,
      the respective plant measurement point information for each of the least one measurement points,
      the attributed operation states.

Any disclosure and embodiments described herein relate to the methods, the systems, the treatment devices, the computer program product lined out above and vice versa. Advantageously, the benefits provided by any of the embodiments and examples equally apply to all other embodiments and examples and vice versa.

As used herein “determining” also includes “initiating or causing to determine”, “generating” also includes “initiating or causing to generate” and “providing” also includes “initiating or causing to determine, generate, select, send or receive”. “Initiating or causing to perform an action” includes any processing signal that triggers a computing device to perform the respective action.

In the context of the present disclosure “chemical plant” may refer to any manufacturing facility based on chemical processes, e.g. transforming a feedstock to a product using chemical processes. In contrast to discrete manufacturing, chemical manufacturing is based on continuous or batch processes. As such monitoring and/or controlling of chemical plants is time dependent and hence based on large signal time series data sets. A chemical plant may include more than 1.000 measurement points producing measurement data points every couple of seconds. Such dimensions result in multiple terabytes of data to be handled in a system for controlling and/or monitoring chemical plants. A small-scale chemical plant may include a couple of thousand measurement points producing data points every 1 to 10 s. For comparison a large-scale chemical plant may include a couple of ten-thousand measurement points, e.g. 10.000 to 30.000, producing data points every 1 to 10 s. Contextualizing such data results in the handling of multiple hundred gigabytes to multiple terabytes.

Chemical plants may produce a product via one or more chemical processes transforming the feedstock via one or more intermediate products to the product. Preferably a chemical plant provides an encapsulated facility producing a product, that may be used as feedstock for the next steps in the value chain. Chemical plants may be large-scale plants like oil and gas facilities, gas cleaning plants, carbon dioxide capture facilities, liquefied natural gas (LNG) plants, oil refineries, petrochemical facilities or chemical facilities. Upstream chemical plants in petrochemicals process production for example include a steamcracker starting with naphtha being processed to ethylene and propylene. These upstream products may then be provided to further chemical plants to derive downstream products such as polyethylene or polypropylene, which may again serve as feedstock for chemical plants deriving further downstream products. Chemical plants may be used to manufacture discrete products. In one example one chemical plant may be used to manufacture precursors for polyurethane foam. Such precursors may be provided to a second chemical plant for the manufacture of discrete products, such as an isolation plate comprising polyurethane foam.

The value chain production via various intermediate products to an end product can be decentralized in various locations or integrated in a Verbund site or a chemical park. Such Verbund sites or chemical parks comprise a network of interconnected chemical plants, where products manufactured in one plant can serve as a feedstock for another plant.

Chemical plants may include multiple assets, such as heat exchangers, reactors, pumps, pipes, distillation or absorption columns to name a few of them. In chemical plants some assets may be critical. Critical assets are those, which when disrupted critically impact plant operation. This can lead to manufacturing processes being compromised. Reduced product quality or even manufacturing stops may the result. In the worst-case scenario fire, explosion or toxic gas release may be the result of such disruption. Hence such critical assets may require more rigorous monitoring and/or controlling then other assets depending on the chemical processes and the chemicals involved. To monitor and/or control chemical processes and assets multiple measurement points. Such measurement points may be actors and sensors. Such actors or sensors may provide plant specific data. Plant specific data may be process or asset specific data relating to e.g. the operating status of an individual asset, the operating status of an individual actor, the composition of a chemical, or the operating status of a chemical process. In particular, process or asset specific data include one or more of the following data categories:
process operation data, such as composition of a feedstock or an intermediate product,
process monitoring data, such as flow, material temperature, pressure
asset operation data, such as current, voltage, and
asset monitoring data, such as asset temperature, asset pressure, vibrations.

A chemical plant may comprise one or more process groups. A process group may be a group of unit operations in a plant, e. g. that perform a macroscopic step in a process. A Process group may comprise a unit operation. A process group in a plant may be a section in a chemical plant that share the same operating state. In particular, a process group may comprise a process line.

As used herein “aggregation” of measurement points may be understood a grouping measurement points according to their relation. This may be a technical relation. Technical related may comprise information, to which process group the measurement points may belong.

The plant specific signal time series data from at least one measurement point in the chemical production plant may be received at the processing device from a storage medium. The storage medium may e. g. be a volatile memory, a hard disk, a cloud service, a data base. The plant specific signal time series data may comprise actual values from at least one of the at least two measurement points. The measurement points may have a certain kind, depending on whether they are sensors or actors. Measurement points may be distinguished by kind. Measurement points may also be distinguished by type. The type of sensor may refer to the type of signal time series data that is provided, e. g. temperature measurements.

Operating states refer to states of operations of a plant and may comprise operating states of one or more process groups in the plant. These may be states a plant may adopt and/or states that a process group may adopt. Some examples of prominent suitable operating states are described below.

Suitable operating states may be on-states, which may refer to an operating status where the chemical plant is running e. g. production. On a more detailed level the on-state may refer to an operating state of a process group while running. On operating states may refer to a production process.

Suitable operating states may be stable states, stable states may be on states where the plant is operating under stable conditions. On a more detailed level the stable states may refer to a process group operating under stable conditions Stable conditions may be conditions wherein the process runs within predefined specifications.

Suitable operating states may be off states, which may refer to a status where the plant is not running. On a more detailed level the off states may refer to a process group not running. Off operating states may refer to an operating status where there is no production process. This may be due to maintenance.

Suitable operating states may be start up states, start-up states may be states, where the plant is starting up and is already in an on state, but not in a stable state. In more detail a process group is starting up for running a process and is already in an on state, but not in a stable state. This is may be a state, where production is already running, but the performance quality of the product is not yet in specification, leading to waste.

Suitable operating states may be shut down states, shut down states may be states, where the plant is shutting down, but is still in an on-state. In more detail shut down state may refer to a process group shutting down but being still in an on state. This is may be a state, where production is still running, but the performance quality of the product is not yet in specification, leading to waste.

Suitable operating states may be event states, event states may be states where the plant is in an on state but not in a stable state, hence undergoing an event. During events the plant may be in a state that is not stable. This may be due to errors/failures in the process or during start up states or shut down states.

Different event types may exist, e. g. start up, shut down and failure events.

Shut down states and start up states may be a subgroup of event states, wherein start up states may follow off states and shut down states may precede off states Failures may be a subgroup of event states, and may be preceded and followed by stable states.

A processing device may be a processor, a network of processors, a computer network comprising one or more computer comprising one or more processors, dedicated processor for each of the steps. Some or all steps may be performed on one processing device or on a group of processing devices.

It is an objective of the present invention to provide a reliable and robust determination of operating states of a chemical plant.

Using scores allows determination of the operating state independent from actual values of the measurement point data. For illustration, purposes the following example is provided. A threshold for a temperature sensor may be used to discriminate between an on or an off state. In an off state the temperature sensor may be the ambient temperature. The ambient temperature may however in hot summers pass the threshold that discriminates the on from the off state. In that case, a wrong operation state would be determined. This is avoided by determining an on/off score that is independent from the actual values.

The step of determining at least one respective signal time series score for the specific signal time series data provides an abstraction layer. This is in particular useful when signal time series data from multiple measurement points are provided. The abstraction layer has the advantage that signal time series scores from different measurement points can be compared or mathematical operations can be performed on the signal time series scores. For example, signal time series scores from signal time series generated from one type of measurement points (e. g. temperature) can be compared to each other or mathematical operations can be performed.

In an embodiment, the respective signal time series score associated with a measure of a degree of variation of the signal time series data over time, may also be referred to as an on/off score.

Determining at least one respective signal time series score for each of the at least one signal time series per each of at least one measurement point may be understood as determining based on the signal time series data associated with the first measurement point in a chemical plant a respective signal time series score associated with a measure of a degree of variation of the signal time series data over time.

In an embodiment determining the signal time series data associated with the first measurement point in a chemical plant a respective signal time series score associated with a measure of a degree of variation of the signal time series data over time may comprise determining a volatility score. The volatility score may be based on volatility. Volatility describes the degree of variation of a signal time series over time. Determination of volatility on signal time series is described for example in Somarajan, Siddarth & Shankar, Monica & Sharma, Tanmay & Ramasamy, Jeyanthi. (2019). Modelling and Analysis of Volatility in Signal time series Data: Proceedings of ICSCSP 2018, Volume 2. 10.1007/978-981-13-3393-4_62. Volatility has the advantage that a dimensionless and scale invariant score is provided.

In an embodiment determining the signal time series data associated with the first measurement point in a chemical plant a respective signal time series score associated with a measure of a degree of variation of the signal time series data over time may comprise determining an activity score.

In an embodiment the at least one respective signal time series score may be activity. Activity is associated with the likelihood of having unique values in a signal time series over a certain period of time. The activity score is based on the concept of near zero variance predictors.

Volatility and activity are interpretable scores, which allows verification of the scores.

In an embodiment, the method further comprises the step of determining the volatility score and the activity score and determining the operating state based on respective signal time series score associated with a measure of a degree of variation of the signal time series data over time comprises determining based on the volatility and the activity score. This increases reliability of the determination, because two independent scores are considered.

In an embodiment determining at least one respective signal time series score for each of the one signal time series per each of at least one measurement point may comprise determining a signal time series score describing outliers relative to the signal time series.

In an aspect determining at least one respective signal time series score for each of the one signal time series per each of at least one measurement point may comprise determining an activity score.

In an embodiment, the method, further comprises,
providing signal time series data associated with a second measurement point in a chemical plant,
determining based on the signal time series data associated with the second measurement point an on/off score associated with a measure of a degree of variation of the second signal time series data over time,
and wherein determining the operating state comprises determining the operating state based on the on/off score of the first time series data and the second time series data.

Determining the operating state based on time series data provided from more than one measurement point increases reliability of the determination of the operating state. This is important, as monitoring and/or controlling of a plant requires high reliability. In particular in chemical plants, where failures in process control may lead to hazardous conditions. While the advantage is disclosed in relation to two measurement points, it is apparent that more than two measurement points can be included.

In an embodiment the measurement point information is provided for the first and the second measurement point and wherein the measurement point information comprises a technical relation indicator.

In an embodiment determining the operating state is further based on the technical relation indicator in particular, the step of determining the operating state comprises determining the operating state based on the on/off score of the first signal time series data and the second time series data only if the technical relation indicator indicates that the measurement points are technically related, in particular belong to one process group.

Signal time series data that are technically related may share the same operating state, e.g. ON/OFF. This allows to reduce ambiguities when determining the operating states of the chemical plant, in particular the operating state of a process group. In an example, the operating states of various measurement points that are technically related may be averaged and the operating state may be determined based on the average. In other examples a majority vote between the measurement points may additionally be used to determine the operation state.

In an embodiment, the method comprises the step of aggregating sensors based on their technical relation.

In an embodiment the determining the operating state is based on the on/off score and a respective cluster classifier.

A respective cluster identifier allows for each signal time series value an unambiguous determination whether this is attributed to an on state or an off state.

The respective cluster classifier for determining the operating state based on the on/off score and the respective classifier is an ON/OFF cluster classifier.

In one embodiment the signal time series data may be clustered based on a signal time series score that varies around two distinct signal time series score values. These two distinct signal time series score values may then be attributed to on or off operating states of the respective process group. This allows an easy labeling of plant specific signal time series data according to on and off operating states of the process group. In an alternative, the cluster classifier may be a threshold and the signal time series data of a measurement point may be clustered dependent on whether they are above or below the threshold.

In an embodiment, determining the operating state comprises determining an on or an off state.

In an embodiment, the method may further comprise the step of segmenting the time series data based on the determined operating state.

In an embodiment, the signal time series data are segmented based on the on and/or off state. By that on states and/or off states are ordered in time. This provides a reduced set of information, the binary state representation needs less storage for saving.

In an embodiment, the method further comprising selecting signal time series data associated with an ON-state and determining a stability score on the selected signal time series.

This reduces the amount of data for which the stability score needs to be assessed. Which reduces storage capacity, memory capacity and computational power needed. Furthermore, it allows to determine stable operating states that are related to operation of the plant, in particular to operation of process groups. Measurement points from a process group or from a plant in an Off-state would be accounted for as stable operating conditions. However, this would be only stable OFF. This may be in particular problematic, when measurement points that are related to an OFF state are grouped with measurement points that are related to an ON-state.

In an embodiment the stability score may be the at least one respective signal time series score.

The stability score may be based on a measure associated with a degree the signal time series does change over time, in other words signal values of the signal time series data do not depend on the time at which the signal series is observed.

In an embodiment, the method further comprises determining a stable operation based on the stability score and a respective cluster classifier.

The respective cluster classifier for determining the operating state based on the stability score is a stability cluster classifier.

In one embodiment the signal time series data may be clustered based on a stability score that varies around two distinct signal time series score values. These two distinct signal time series score values may then be attributed to stable or instable operating states of the respective process group. This allows an easy and reliable identification of stable and instable operating states of the plant or the process group. In an alternative, the stability cluster classifier may be a threshold and the signal time series data of a measurement point may be clustered dependent on whether they are above or below the threshold.

This enables easy and reliable determination of stable operating states and/or events.

discrimination of plant specific signal time series data according to stable and instable operating states of the process group.

Determining a stability score allows determining stable operating states of the plant. This is the desired operation status of the plant. Stable operating conditions are mandatory for a consistent product quality and also relate to process conditions with reduced need of energy. Instable operating conditions may be indicative of an event.

In an embodiment, the stability score may be associated with an anomaly score.

The anomaly score describes outliers relative to a standard signal. Various ways for determining an anomaly score are known in the art (ARIMA—G. E. P. Box, G. M. Jenkins: Signal time series analysis: Forecasting and control. Holden-Day, San Francisco 1970; STL decomposition, Cleveland, R. B. et. al. 1990. STL: A seasonal t rend decomposition procedure based on loess Journal of Official Statistics6(1):3-73). Another method suitable for determining the anomaly score is the hybrid seasonal extreme studentized deviate test (HSESD, Automatic Anomaly Detection in the CloudVia Statistical LearningJordan Hochenbaum et al., arXiv:1704.07706v1, Submitted on 24 Apr. 2017).

The anomaly score has the advantage that a dimensionless and scale invariant score is provided. The anomaly score provides values between a lower and an upper value. This may then be normalized to an arbitrary value range between 0 and 1. Normalizing to a value range between 0 and 1 increases comparability.

In an embodiment the stability score may be a stationarity score. Stationarity describes that statistical properties of a signal time series (or rather the process generating it) do not change over time. Various ways for determining stationarity of signal time series are known in the art (e. g. Dickey, D. A. and W. A. Fuller: Distribution of the Estimators for Autoregressive Signal time series with a Unit Root, Journal of the American Statistical Association, 1979, 74, S. 427-431; Kwiatkowski, D.; Phillips, P. C. B.; Schmidt, P.; Shin, Y. (1992). “Testing the null hypothesis of stationarity against the alternative of a unit root”. Journal of Econometrics. 54 (1-3): 159-178.). The stationarity score has the advantage that a dimensionless and scale invariant score is provided.

The stationary score may provide values between a lower and an upper value. This may then be normalized to an arbitrary value range between 0 and 1. Normalizing to a value range between 0 and 1 increases comparability.

In an embodiment, the method may further comprise providing data associated with the operating state of the chemical plant, suitable for monitoring and/or controlling the chemical plant, comprising data associated with an ON-state further comprising providing data associated with a stable operation of the plant.

As mentioned above stable operating conditions are desired and for monitoring and controlling it is important to determine if the plant is in a stable operating state. If the plant is in a stable operating monitoring may be sufficient, whereas in case an instable operating condition occurs, the plant may be initiated to stop in order to prevent hazardous conditions of the plant. This way an early alarm system is enabled. Increasing safety of the chemical plant.

In an embodiment, the method may comprise the step of determining an event based on the stability score. An event may be determined, when the stability score indicates instable operation.

In an embodiment, determining of the operating state may comprise determining of an event type dependent on previous operating states. This enables differentiating normal operation states like start up and shut down phases from failure events. Failure events are potentially dangerous.

In an embodiment, stable operating points of the plant may be determines based on the stable operating states. Stable operating points may be defined by signal time series from measurement points. Determining of stable operating points is crucial for efficient performance of chemical plants and may be closely related with the product quality.

In an embodiment, the method may further comprise providing signal time series data from a measurement point and receiving data associated with the operating state of the chemical plant, suitable for monitoring and/or controlling the chemical plant, in particular providing from a client device and receiving with a client device.

In an embodiment signal time series scores from signal time series generated from different type of measurement points (e. g. temperature, pressure) may be compared to each other or mathematical operations can be performed.

The at least one signal time series score may be scale invariant. Scale invariant signal time series scores provide an advantage when signal time series scores from signal time series generated from one type of measurement points (e. g. temperature) shall be compared to each other or mathematical operations shall be performed.

The at least one signal time series score may be dimensionless. Dimensionless signal time series scores provide an advantage when signal time series scores from signal time series generated from different type of measurement points (e. g. temperature, pressure) shall be compared to each other or mathematical operations shall be performed.

The respective signal time series score may be a signal time series in itself.

For determining respective signal time series scores from the specific signal time series data from at least one measurement point in the chemical production plant, it is beneficial to define bins. A bin may comprise a sequence of signal time series data. The sequence may be chosen such that a sufficient amount of sensor data is available for determining the respective signal time series scores. A sufficient amount of data may comprise at least 25 data points.

Additionally, the sequence of signal time series data may be chosen according to a time constant of the plant. In particular, the sequence may be shorter than a dynamic time constant of the process to be monitored. Suitable time constants may be time of a start-up and/or shutdown procedure of a plant. A sequence shorter than a time constant of the process is beneficial. It secures that the information of the signal time series data is maintained and different operational conditions in the plant are not mixed. The bin may then be moved along the signal time series as a sliding window. The at least one signal time series score may vary as a function of time.

In an embodiment determining at least one respective signal time series score for each of the one signal time series per each of at least one measurement point comprises determining a signal time series score describing to what degree statistical properties of each of the one signal time series per each of at least one measurement point over time are not changing over time.

The step of determining at least one respective signal time series score for the specific signal time series data may comprise determining two or more respective different signal time series scores.

Determining two or more respective signal time series scores may have the advantage that each of the two or more respective signal time series may have different sensitivity to different operating states of process group.

A signal time series score is be considered sensitive to a certain change in the operating status of a plant when the respective change in the operating status of the operating status is reflected in a change in the signal time series score.

In an embodiment a rule set may be provided, the rule set relating a cluster of a signal time series score to an operating state. In an aspect the rule set may comprise relating a combination of signal time series scores of a respective time series to an operating state.

For example volatility and activity may be sensitive to on/off operating states of the plant and less sensitive to changes throughout an on operating status of a plant. An on operating status of a plant may refer to a plant in production or a process group of a plant in production. The off operating status of a plant may refer to a plant or a process group of the plant not being in production. Volatility and anomaly are then well suited for identifying on/off operating states in a plant or a process group of a plant.

In an embodiment a rule set for volatility clusters may then define that a high volatility score relates to an on state e. g. of the process group and that a low volatility relates to an off state off e. g. of the process group.

In an embodiment a rule set for activity clusters may then define that a high activity score relates to an operating state on of the process group and that a low activity relates to an operating state off of the process group.

In another example anomaly score and stationary score may be sensitive to on/off operating states of the plant but also sensitive to changes during the on process of the plant. Then these scores maybe a good indicator for changes during the on process of the plant, but not a good indicator for on/off operating states of the process group of the plant.

In an aspect a rule set for instability score clusters may define that a high instability score relates to an instable operating state and that a low instability score relates to an instable operating state. In an aspect high and low are defined with respect to a threshold line.

In an embodiment a rule set for anomaly score clusters may define that a high anomaly score relates to an instable operating state and that a low anomaly score relates to an instable operating state. In an aspect high and low are defined with respect to a threshold line.

Providing plant measurement point information for the at least one measuring point provides additional information on the signal time series data.

In an aspect the plant measurement point information may refer to the kind of measuring point, the kind of measuring point distinguishes what device provides the data, e. g. whether it is a sensor or an actor.

In an aspect the plant measurement point information may refer to the type of measurement point. The type of sensor may refer to the type of signal time series data that is provided, e. g. temperature measurements may be assigned the same type.

In an aspect the plant measurement point information may comprise a technical relation indicator, indicating the technical relation to a process group in the plant. The technical relation indicator may indicate that measurement points of different kinds or types are technically related to each other as belonging to the same process group. This is beneficial as it allows aggregation of sensors according to their technical relation, e. g. in a process group. By this, the operating state of the plant can be provided with a resolution on the level of process groups. This adds additional information, as measurement points that are technically related, e. g. from one process group share the same operating state. In the example of the

This allows to base the determination of the operating state of the plant on sensors that belong to the same process group. Which in turn makes enhances reliability of the determination of the operating state. Providing the technical relation indicator of a measurement sensor is beneficial because it provides additional context to the signal time series. In a plant that has multiple identical production lines the technical relation indicator may refer to a specific production line. The identical production lines may each be different operating states. In an embodiment, the technical relation indicator is based on the location of the measurement points.

Providing the type of a measurement sensor is beneficial, because it provides additional context to the signal time series. Temperature changes may for example be slow, while pressure changes may be fast in a specific scenario.

In an embodiment the plant measurement point information refers to least one of the list of kind of measurement point, a type of measurement point and a technical relation indicator.

The plant measurement point information may be provided from process and instrumentation diagrams (P&ID). These diagrams are frequently used for describing plants in chemical industries. In an alternative the plant measurement point information may be provided from a graph representation of the plant.

The step of clustering in clusters the annotated signal time series based on the at least one determined respective signal time series score and a cluster classifier, provides additional information on the operating status of a process group in a particular section of the signal time series data. Clustering may be understood as the task of grouping a set of objects in such a way that objects in the same group (called a cluster) are more similar (in some sense) to each other than to those in other groups (clusters). For the purpose of this application the objects are signal time series representing the respective signal time series score.

The step of clustering in clusters the annotated signal time series based on the at least one determined respective signal time series score, provides additional information in revealing which signal time series data have similar signal time series scores.

In an aspect the step of clustering the annotated signal time series data based on the least one determined respective signal time series score may comprise clustering based on a respective cluster classifier.

In an embodiment the cluster classifier may be provided a priory.

In another aspect the cluster classifier may be amended based on the respective signal time series scores.

The cluster classifier may comprise a threshold and clusters are formed dependent on whether a signal time series score value is above the threshold or below the threshold.

The cluster classifier may comprise two distinct clusters and clustering is performed dependent on the likelihood a signal time series score value belongs to one of the two distinct clusters. Examples for suitable methods for clustering may be K-Means Clustering,

The cluster classifier may be amended by unsupervised learning.

In an embodiment clustering may be performed by unsupervised learning. Various mechanisms for clustering and unsupervised learning for signal time series data are described in the review article (Pattern Recognition 38 (2005) 1857-1874, Clustering of signal time series data—a survey, Warren Liao).

In an embodiment clustering may be performed by defining a threshold and clusters are formed dependent on whether a signal time series score value is above the threshold or below the threshold.

Unsupervised learning is in particular useful if the signal time series scores vary around two distinct signal time series score values. Unsupervised learning is useful for large datasets, because there is no need for manually labeling data for a training data set.

In one embodiment the signal time series data may be clustered based on a signal time series score that varies around two distinct signal time series score values. These two distinct signal time series score values may then be attributed to on or off operating states of the respective process group. This allows an easy labeling of plant specific signal time series data according to on and off operating states of the process group.

In one embodiment the signal time series data may be clustered based on the volatility score.

The volatility score varies around two distinct volatility score values. These two distinct volatility values may then be attributed to on or off operating states. This allows an easy labeling of plant specific signal time series data according to on and off operating states.

Unsupervised learning is in particular useful if the signal time series scores exhibit a small number of distinct score values. The volatility score generally exhibits a binary behavior of the score value.

In an embodiment the step of clustering the annotated signal time series data based on the least one determined respective signal time series score may comprise clustering based on the volatility score.

In an embodiment clustering of the volatility score may be performed by unsupervised learning. In an embodiment one of these volatility score clusters may be attributed to the on, the other of the volatility score clusters may be attributed to the off state.

Unsupervised learning is in particular useful if the signal time series scores exhibit a small number of distinct score values. The activity score generally exhibits a binary behavior of the score value.

In one embodiment the signal time series data may be clustered based on the activity score.

The activity score varies around two distinct volatility score values. These two distinct volatility values may then be attributed to on or off operating states of the respective process group. This allows an easy labeling of plant specific signal time series data according to on and off operating states.

In an embodiment clustering of the activity score may be performed by unsupervised learning. In an aspect one of these activity score clusters may be attributed to the on state, the other of the activity score clusters may be attributed to the off state.

In an aspect clustering the annotated signal time series based on a least one determined respective signal time series score comprises clustering based on the volatility score and clustering based on the activity scores. A method for clustering signal time series in two dimensions multivariate clustering can be used. An appropriate model is disclosed by Zhou, Pei-Yuan et. al. (2014); A Model-Based Multivariate Signal time series Clustering Algorithm.

In one aspect clustering in clusters the annotated signal time series based on the at least one determined respective signal time series score, may be based on the signal time series score describing outliers relative to the signal time series.

In an aspect the step of clustering the annotated signal time series data based on the least one determined respective signal time series score may comprise clustering based on the anomaly score. The anomaly score varies between a lower and an upper bound.

In an aspect the step of clustering the annotated signal time series data based on the anomaly score may be performed defining an anomaly threshold and clusters are formed dependent on whether an anomaly score value is above the anomaly threshold or below the anomaly threshold.

A cluster where the anomaly score is above the anomaly threshold may be attributed to an event state.

A cluster where the anomaly score is below the anomaly threshold may be attributed to a no event state.

In one aspect clustering in clusters the annotated signal time series based on the at least one determined respective signal time series score, may be based on a signal time series score describing to what degree statistical properties of each of the one signal time series per each of at least one measurement point over time are not changing over time.

In an aspect the step of clustering the annotated signal time series data based on the least one determined respective signal time series score may comprise clustering based on the stationarity score. The stationarity score varies between a lower and an upper bound.

In an aspect the step of clustering the annotated signal time series data based on the stationarity score may be performed defining a threshold and clusters are formed dependent on whether a stationarity score value is above the threshold or below the threshold.

A cluster where the stationarity score is above the stationarity threshold may be attributed to a stable operating state.

A cluster where the stationarity score is below the stationarity threshold may be attributed to an instable operating state.

A cluster may be attributed to a start up state, when the event state is preceded by an off state. A cluster may be attributed to a shut down state, when the event state is followed by an off state.

From the definition of anomality and stationarity it is clear that the detection of an anomality is prohibitive for a stationarity. When an event state is detected, no stable operating state can be reached.

Labels may be provided based on the clustering. In an aspect labels for on/off operating states of the process group may be provided.

In another aspect labels for anomaly/no anomaly may be provided. In another aspect labels for stationarity/non stationarity may be provided.

The signal time series is now contextualized and may be used for further evaluation.

In an embodiment the at least one measurement point in the chemical production plant comprises two or more measurement points and wherein the method further comprises,
selecting one or more of the at least two measurement points based on the respective plant measurement point information
determining at least one respective signal time series score only for each of the one signal time series per each of the selected one or more measurement points.

Selecting one or more of the at least two measurement points based on the respective plant measurement point information and determining the at least one respective signal time series score only for each of the one signal time series per each of the selected one or more measurement points has the advantage that not all signal time series from all measurement points have to be assessed. This greatly reduces processing time.

In an embodiment selecting one or more of the at least two measurement points based on the respective plant measurement point information may comprise selecting based on the technical relation indicator of measurement point.

Selecting the signal time series data of the at least two measurement points based on the plant measurement point information may provide more robust results for clustering, as only meaningful measurement points may be selected.

As an example, one could consider to be only interested in the on/off operating status of a specific process group. By selecting only measurement points related to the specific process group. In this example the selection is based on the plant measurement point information indicator.

The clustering may then only be applied to signal time series that are selected. This may be beneficial if it is known that a respective signal time series score is sensitive for a specific operating status of the plant. For example, flow sensors react fast on changes of reactant flow and reactants only flow when the operating status of the process group is on.

In an embodiment selecting one or more of the at least two measurement points based on the respective plant measurement point information may comprise selecting based on the type of measurement point.

Selecting the signal time series data of the at least two measurement points based on the type of measurement point may provide more robust results for clustering, as only meaningful measurement points may be selected.

As an example, when there is only interest in signal time series data from more than one measurement point based on the type of measurement point one could select only measurement points related to the specific type of measurement points. In this example the selection is based on the type of measurement point. The clustering may then only be applied to signal time series that are selected.

In an embodiment selecting one or more of the at least two measurement points based on the respective plant measurement point information may comprise selecting based on the kind of measurement point.

In an embodiment the step of clustering in clusters the annotated signal time series based on the at least one determined respective signal time series score, may comprise to clustering the annotated signal time series only for each of the one signal time series per each of the selected one or more measurement points

This has the advantage that only selected signal time series are used for clustering. Clustering is a computational expensive task; therefore, it is beneficial to select signal time series data from more than one measurement point based on the plant measurement point information. This may substantially reduce the signal time series data that need to be evaluated for clustering.

In an embodiment the method may further comprise the step of aggregating the at least one respective signal time series score for each of the one signal time series per each of the selected one or more measurement points.

Aggregating may be e. g. summing, averaging, weighting.

Aggregation of respective signal time series scores over the selected measurement points may increase the signal to noise ratio in the signal time series score.

Aggregation of respective signal time series scores over the selected measurement points may increase the robustness in the following clustering process.

In an embodiment the annotated signal time series may be stored. Storing the annotated signal time series has the advantage that the computational expensive task of the determined at least one respective signal time series score for each of the one signal time series per each of at least one measurement point does not have to be reiterated when processing of the data is further evaluated at a later point in time.

In an embodiment
determining at least one respective signal time series score for each of the one signal time series per each of at least one measurement point comprises determining a respective volatility and/or respective activity score and
clustering in clusters the annotated signal time series based on the at least one determined respective signal time series score comprises clustering based on the respective volatility and/or the respective activity score and
the attributed operating state is an on state.

In one embodiment determining a signal time series score describing outliers relative to the signal time series requires the attributed on state.

In one embodiment determining at least one respective anomaly score for each of the one signal time series per each of at least one measurement point requires the attributed on state.

In one embodiment determining to what degree statistical properties of each of the one signal time series per each of at least one measurement point over time are not changing over time requires the attributed on state.

In one embodiment determining at least one respective stationary score for each of the one signal time series per each of at least one measurement point requires the attributed on state.

In an embodiment respective anomaly scores are only determined on signal time series attributed to an on state. Off states of a plant or process group are likely not interesting for data analysis. By determining the anomality score for only the signal time series that are attributed to an on state, irrelevant data does not have to be assessed. This greatly reduces computational time.

In an embodiment respective stationarity scores are only determined on signal time series attributed to an on state.

In an embodiment respective stationarity scores are only determined on signal time series attributed to an on state. Off states of a plant or process group are likely not interesting for data analysis. By determining the stationarity score for only the signal time series that are attributed to an on state, irrelevant data does not have to be assessed. This greatly reduces computational time.

In an embodiment the method may further comprise the step of deriving statistical values for each of the signal time series data of the at least two sensors. The statistical values may be e. g. mean, median, variances, standard deviations, quantiles, quartiles percentiles, missing values. These statistical values allow to determine the information content of the signal time series data. This allows to define limits to the signal time series data and depending on these limits to exclude sequences of a signal time series from further evaluation. The processing time can be greatly reduced by excluding signal time series data that does not contain valuable information. For example if the variance of a signal time series is above a certain threshold this may indicate that a sensor provides a noisy signal and that therefore the signal may not be used for further evaluation. Dysfunctional sensors could for example provide a flat signal, and the variance of the signal would hence be low. Consequently, sensor signals with low variance may be excluded from further evaluation.

According to an aspect, a computer program or a computer program product or computer readable non-volatile storage medium comprising computer readable instructions, which when loaded and executed by a processing device perform the methods disclosed herein.

According to an aspect a system is proposed, the system comprising an input device, and output device and a processing device configured for performing the methods disclosed herein.

### BRIEF DESCRIPTION OF THE FIGURES

FIG. 1 shows a block/flow diagram of a computing system for determining operating states of a chemical plant

FIG. 2 shows an exemplary workflow in accordance with the disclosure

FIG. 3 shows an illustrative example of a plant

FIG. 4 shows a detailed view of a process group of the illustrative plant

FIG. 5 depicts an example of sensor data and the concatenating process

FIG. 6 illustratively depicts a data flow according to the disclosure.

FIG. 7 illustrates how event types may be determined dependent on previous operating states

In FIG. 8 a system for contextualizing signal time series in a chemical production plant is shown

FIG. 9 shows an example of the method of contextualizing signal time series in a chemical production plant

FIG. 10 illustrates the behavior of score signal time series

### DETAILED DESCRIPTION

In the following, the present disclosure is further described with reference to the enclosed figures:

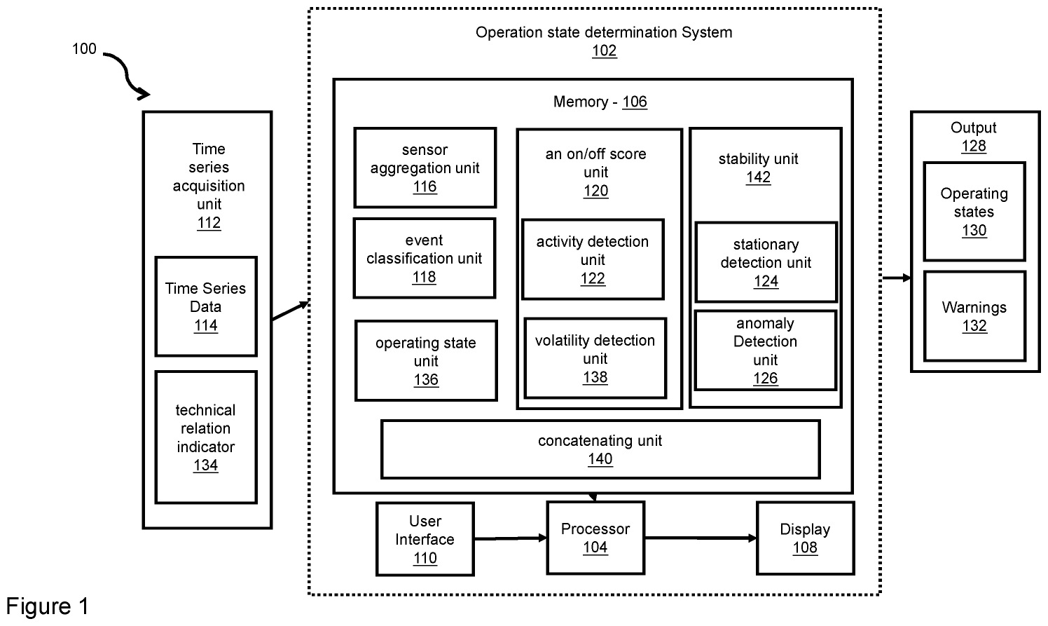

FIG. 1 shows a block/flow diagram of a computing system 100 for determining operation state of a chemical plant in accordance with the disclosure.

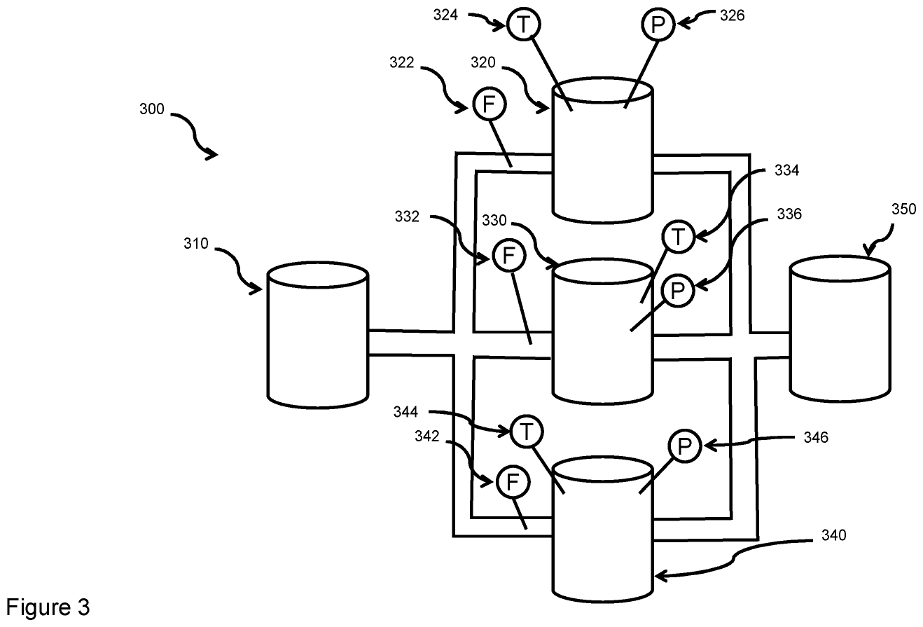

A system for determining the operation state of a chemical plant is denominated 102, via an time series acquisition unit 112, signal time series data 114 associated with a first measurement point in a chemical plant may be provided. In this example signal time series data from more than one measurement point may be provided. The signals time series data may be provided from a database or from measurement points or a combination of both. The signal time series data may be historic signal time series data or current signal time series data. Using historical signal time series data may be useful, when, the information about historic operating states is not available for the historical signal time series data. Use of current signal time series data may be preferred, when monitoring/controlling of a chemical plant is envisioned. In this example, technical relation indicator 134 may be provided for each measurement point. The technical relation data may comprise information about the technical relation between measurement points, e.g. if they belong to the same process group. The example will be described in more detail with respect to the chemical plant shown in FIG. 3. The system 100 may include a workstation or a system 102 a processing device 104. The system preferably includes one or more processors 104 and a memory 106 for storing applications, units, and other data. In one embodiment according to the present disclosure the system 102 may include one or more displays 108 for viewing. The displays 108 may permit a user to interact with the system 102 and its components and functions. This may be further facilitated by a user interface 110, which may include a mouse and or a keyboard.

A sensor aggregation unit 116 may be configured to aggregate signal time series data associated with measurement points in a chemical plant, in this example these may be signal time series provided from three measurement points. In sensor aggregation unit, the time series data are aggregated according to the technical relation indicator 134. In on/of unit 120 a respective signal time series score associated with a measure of a degree of variation of the signal time series data over time is determined based on the signal time series data associated with the first measurement point in a chemical plant. This may be executed by the activity detection unit 122, when an activity score is determined of by a volatility detection unit 138, when a volatility score is determined. In an alternative the volatility score and the activity score may both be determined by their respective detection units. In operating state unit 136 the operating state may be determined based on the respective signal time series score associated with a measure of a degree of variation of the signal time series data over time. Upon selecting of signal time series data associated with an on-state, in stability unit 142 a stability score is determined. The stability score may be determined by stationary detection unit 124 when a stationary score is determined or by anomaly detection unit 126, when an anomaly score is determined. At operating state unit 136 the operating state based on the stability score is determined. This may be stable operation or instable operation, wherein instable operation is associated with an event. Concatenating unit 140 may annotate the signal time series data by concatenating the operation states to the respective signal time series. At output 128, the annotated signal time series data may be provided for storage in a database, not shown.

The system may generate output in block 128, which may include data associated with the operating state of the chemical plant, suitable for monitoring and/or controlling the chemical plant 130 and or warnings 132. In combination with a system for monitoring and/or controlling a plant system 102 may further provide a monitoring/control signal.

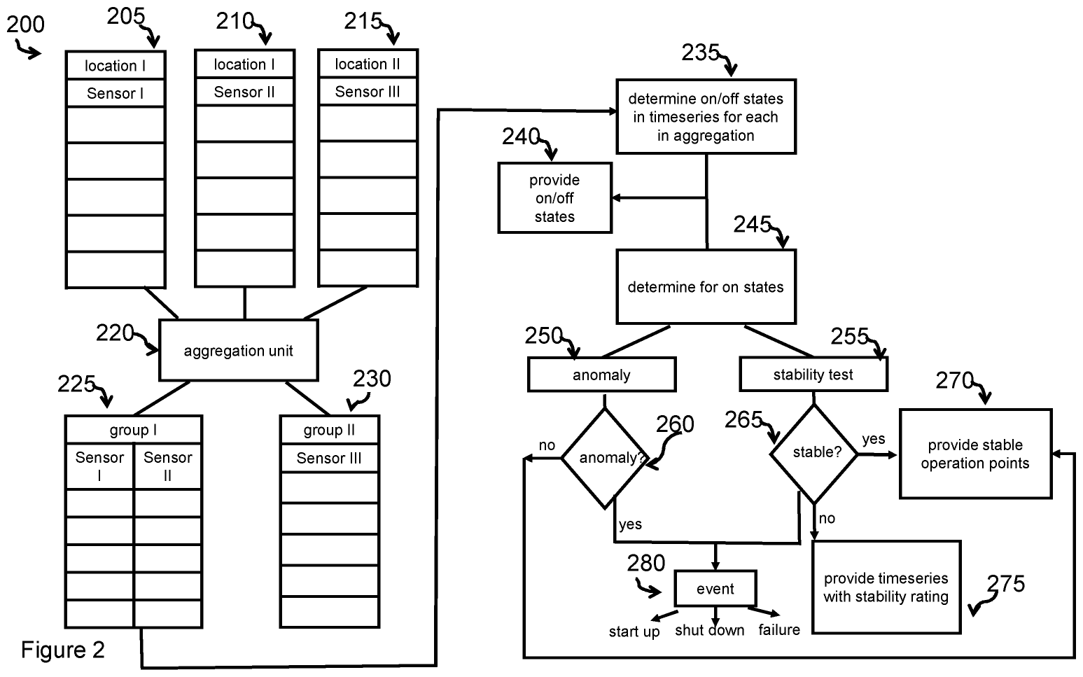

FIG. 2 shows an exemplary workflow in accordance with the disclosure. The workflow is depicted as 200. At 205, signal time series data associated with a first measurement point, a second measurement point 210 and a third measurement point 215 in a chemical plant are provided, the time series data may be data from flow sensor 332, temperature sensor 334 and flow sensor 322 respectively. Measurement point information for each signal time series is also provided at the time series acquisition unit 112. At step 220, the sensor aggregation unit 116 evaluates the technical relation indicator, the technical relation indicator indicates that signal time series relates to process group 330, while signal time series from flow sensor 322 relates to process group 320. In step 225 and step 230, the signal time series are aggregated accordingly. In the following as an example the workflow is continued with sensor group I. At step 235 the on/off states are determined for each sensor in aggregation separately. This is done by determining a volatility score and then based on the volatility score determine the on/off state. While the example describes the flow with respect to the volatility. This refers to the step of determining based on the signal time series data associated with the first measurement point in a chemical plant a respective signal time series score associated with a measure of a degree of variation of the signal time series data over time. At step 235 the operating state based on the respective signal time series score associated with a measure of a degree of variation of the signal time series data over time is determined. In this example this relates to the on/off states. At step 240, the on/off states may be provided. At step 245 only for the determined on states further evaluations are executed. At steps 250 and 255 a stability score is determined. At step 250, the anomaly score is determined and at step 255 the stationary score is determined. At 260 it is determined if the anomaly score indicates an anomaly. If this is not the case stable operating points may be determined at step 270. In a second branch following step 245, the stationary score is determined at 255. If the stationary score indicates a stable operating condition, then step 270 follows, where the stable operating points are provided. By determining the anomaly score and the stationary score it is ensured that a stable operating point is only provided when both scores indicate stable a stable operating status. When at step 260 an anomaly is detected and at step 265 non stationary is detected, then the signal time series may be provided at step 275, wherein the provided signal time series may comprise a stability score for the aggregated sensors. Additionally, or alternatively an event may be determined at step 280. The event type may also be determined dependent on previous operating states. The type of event may be start up, shut down or failure. In case of a failure an alarm signal may be provided for monitoring or a stop signal may be provided for control, wherein the stop signal may stop the plant or the process group respectively.

FIG. 3 shows an illustration of a chemical plant comprising several process groups. In this example the plant comprises different process groups 310, 320, 330, 3340, 350. Process group 310 may be a preprocess group for preprocessing of reactants. process groups 320, 330 and 340 may be production trains. A production train may be a process group, where reactions from reactants provided from the preprocess group 310 to products take place. The plant in this example comprises three identical production trains. All production trains may have individual operating states. In this example the plant further comprises a process group for post processing 350. All production trains may be in communication with the process group for preprocessing and the process group for postprocessing. In this illustrative example, each production train may be equipped various measurement points, configured for providing signal time series data. In this example, the measurement points are sensors. flow sensors 322, 332, 342, temperature sensors 324, 334, 344 and pressure sensors 326, 336, 346 are equipped to their respective process train 320, 330, 340, this is indicated by the first to digits.

Flow sensor 322, temperature sensor 324 and pressure sensor 326 may be technically related e. g. they are equipped at the same process train 320. Flow sensor 332, temperature sensor 334 and pressure sensor 336 may be technically related e. g. they are equipped at the same process train 330. Flow sensor 342, temperature sensor 344 and pressure sensor 346 may be technically related e. g. they are equipped at the same process train 340.

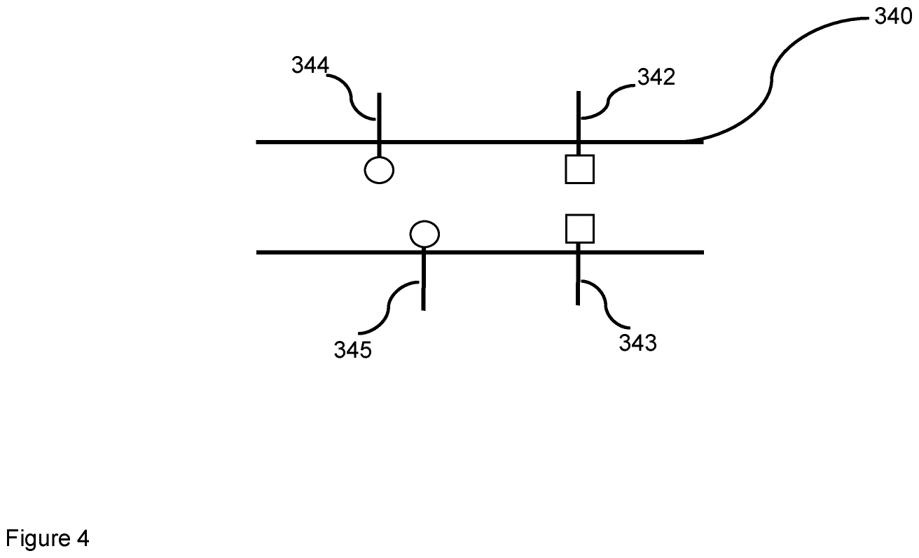

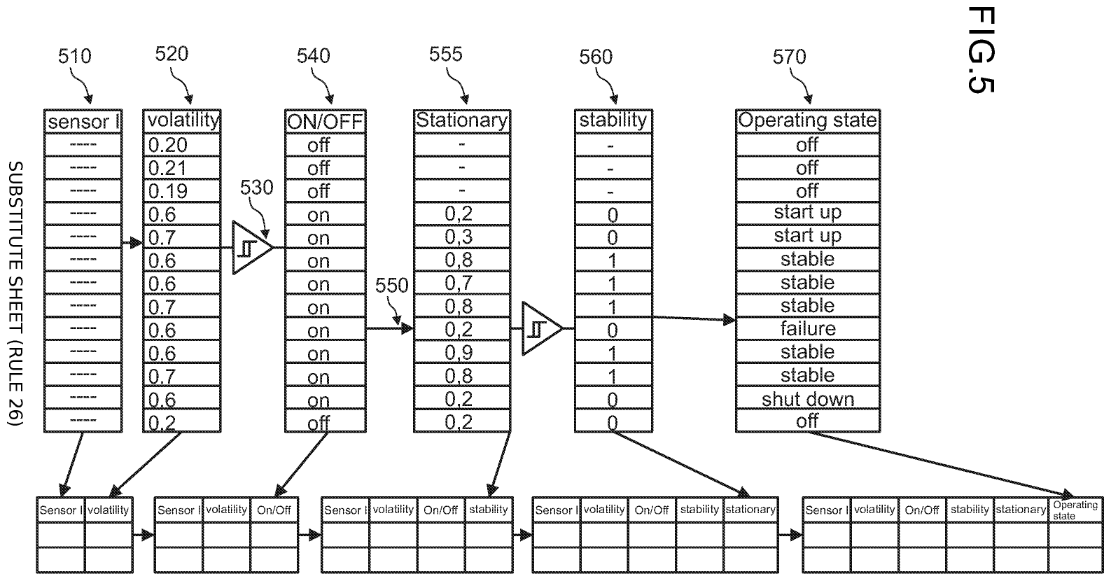

FIG. 4 shows a zoom into the production train 340. The production train may comprise measuring point, in this example the measuring points are a first and second temperature sensor 344, 345 and a first and second flow sensor 342, 343. Plant measuring point information may be provided for each measuring point.

For the first temperature sensor the plant measuring point information may be
kind: sensor;
type: temperature;
technical relation indicator: in process train 340.

For the second temperature sensor the plant measuring point information may be
kind: sensor;
type: temperature;
technical relation indicator: in process train 340.

For the first flow sensor the plant measuring point information may be
kind: sensor;
type: mass flow;
technical relation indicator: in process train 340.

For the second flow sensor the plant measuring point information may be
kind: sensor;
type: volume flow;
technical relation indicator: in process train 340.

FIG. 5 depicts an example of sensor data and the concatenating process. 510 relates to signal time series from sensor 1. From that the volatility 520 is determined and shown the volatility is a time series. in a clustering step 530, the time series data is attributed to off and on operating states 540. In a further determination step 550 a stationary score 555 is determined only for on states. At step 560 the stability of the operating state is determined based on the stationary score. This is done by clustering as describe above. Finally, the operating states 570 are attributed to the signal time series data. In the bottom line from left to right an example of the concatenated signal time series data is shown.

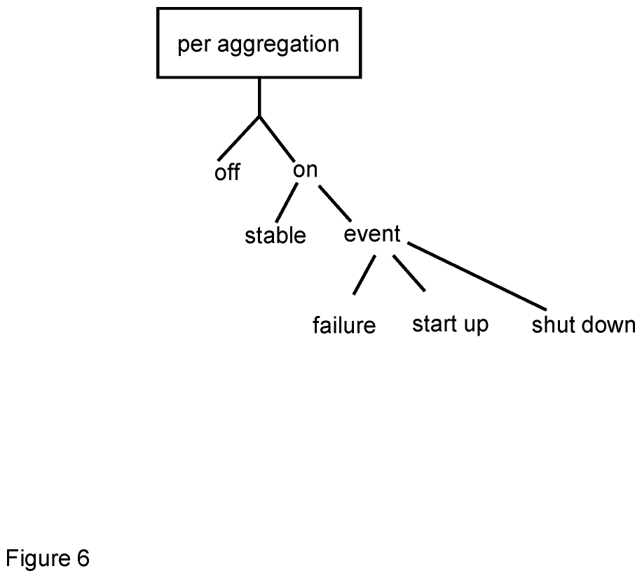

FIG. 6 illustratively depicts a data flow according to the disclosure. Per aggregation, wherein the aggregation comprises signal data from one or more measurement points that are technically related. First between the operating states on and off is discriminated. The signal time series data associated with an on state are then further evaluated, e.g. by determining a stability score as described with reference to FIG. 2. Based on the stability score it is determined whether the operating state is stable or an event was happening. Upon determination of an event, the type of event may further be determined. In this example only three event types are shown. Start up, shut down and failure.

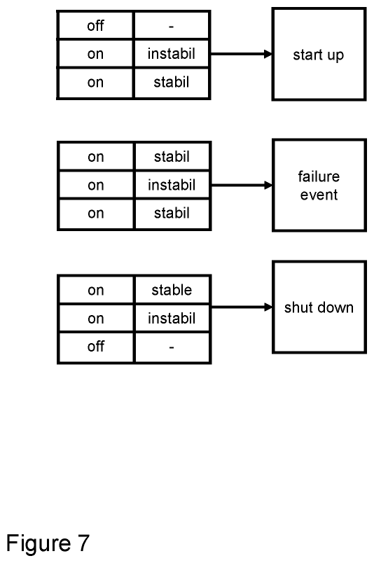

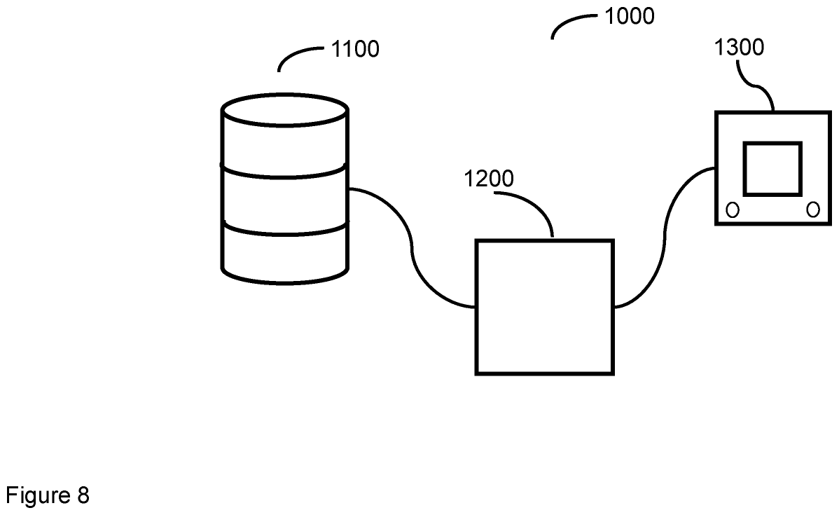

FIG. 7 illustrates how event types may be determined dependent on previous operating states. An off state followed by an on state which is an instable operating state followed by a staple on state may relate to a start up process of a plant.

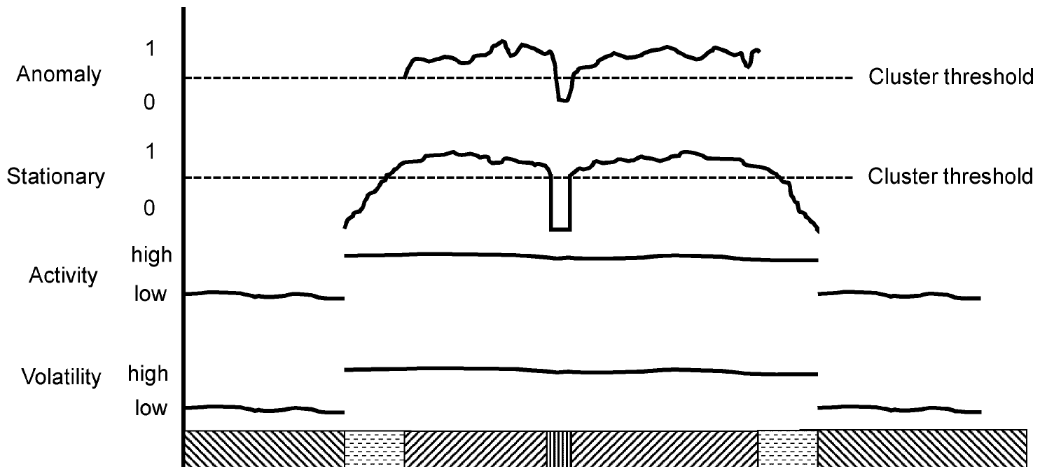

A stable on state followed by an instable on state and then followed by a stable on state may be indication for a failure event. The plant had been running in a stable operating state and recovered to a stable operating state after the failure event. The last example depicts an example where a shut down process can be determined. A stable on state is followed by an instable on state, which is followed by an off state. The example is in line with the sketch in FIG. 10.

In FIG. 8 a system 1000 for contextualizing signal time series in a chemical production plant is shown. The system 1000 comprises an output device 1300, in this example the output device is a monitor for displaying the contextualized signal time series in the chemical plant. Additionally, or alternatively the output device may be a data storage device. Additionally, or alternatively the output device may be a database. Additionally, or alternatively the output device may be a connection to another processing device. The system further comprises an input device 1100 for providing one signal time series per each of at least one measurement point in the chemical production plant. The system further comprises a processing device 1200, for the purpose of this example, the processing device is a multi-purpose computer, but may be any other suitable processing device. The processing device is configured to perform the method for contextualizing signal time series in a chemical production plant.

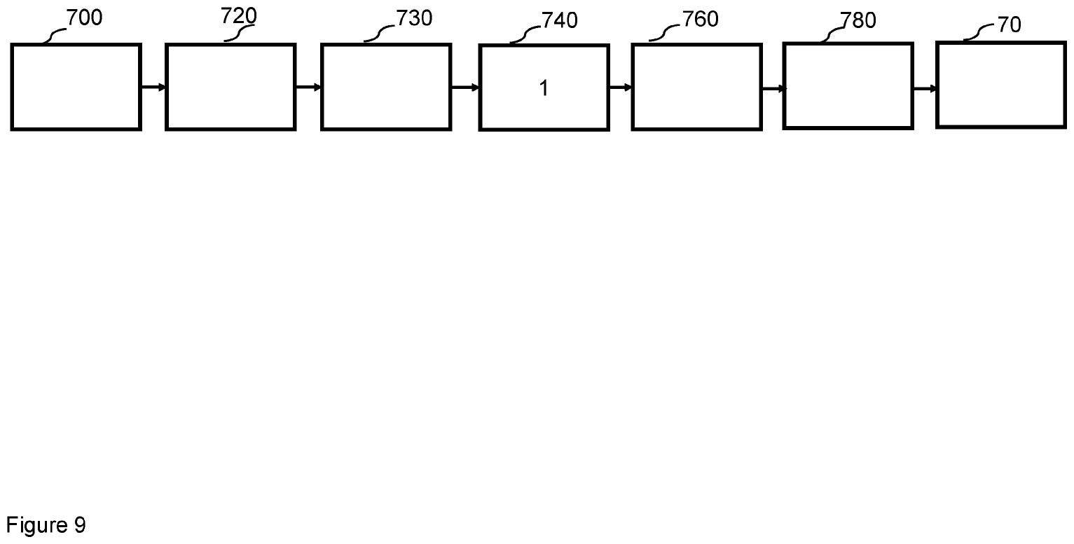

An example of the method of contextualizing signal time series in a chemical production plant is shown in FIG. 9.

At a first step 700 at a processing device receiving one signal time series per each of at least one measurement point in the chemical production plant. In this example a first signal time series from a first time series is received from the first temperature sensor, a second time series is received from the second temperature sensor and a third time series is received from the first flow sensor and a fourth time series is received form the fourth flow sensor.

At a second step 720 providing respective plant measurement point information for each of the least one measurement point, the measurement point information for each of the for sensors is provided.

In this example at step 730 determining at least one respective signal time series score for each of the one signal time series per each of at least one measurement point based on stochastically properties of the signal time series, comprises determining time series an activity score and a volatility score. The activity score and the volatility score are time series.

In this example at step 740 generating annotated signal time series, comprising
the one signal time series per each of at least one measurement point in the chemical production plant,
the determined at least one respective signal time series score for each of the one signal time series per each of at least one measurement point,
the respective plant measurement point information for each of the at least one measurement point, comprises
generating
an annotated signal time series for the first temperature sensor comprising
   the temperature signal time series of the first temperature sensor
   the determined volatility time series for the first temperature sensor
   the determined activity time series for the first temperature sensor
   the plant sensor information for the first temperature sensor
an annotated signal time series for the first temperature sensor comprising
   the temperature signal time series of the second temperature sensor
   the determined volatility time series for the second temperature sensor
   the determined activity time series for the second temperature sensor
   the plant sensor information for the second temperature sensor
an annotated signal time series for the first flow sensor comprising
   the temperature signal time series of the first flow sensor
   the determined volatility time series for the first flow sensor
   the determined activity time series for the first flow sensor
   the plant sensor information for the first flow sensor
an annotated signal time series for the second flow sensor comprising
   the temperature signal time series of the second flow sensor
   the determined volatility time series for the second flow sensor
   the determined activity time series for the second flow sensor
   the plant sensor information for the second flow sensor

The step 760 clustering in clusters the annotated signal time series based on the at least one determined respective signal time series score and a respective cluster classifier is in this example performed on the volatility score of the first temperature sensor. The classifier for the volatility score may comprise two clusters high and low. This is illustrated in FIG. 5. Clustering may be performed by assessing whether a volatility score value is closer to the high or the low cluster. A suitable method is k-means clustering. Clustering may also be performed for the activity score for the first temperature sensor.

In step 780 attributing operation states to the signal time series based on the clustering and a ruleset. In the preceding clustering step all elements of the volatility score of the first temperature sensor are assigned to either the high and low cluster. The rule set for volatility clusters defines that a high volatility relates to an operating state on state of the process group. The rule set for volatility clusters defines that a low volatility relates to an operating state off state of the process group. The rule set is based on the assumption that during the operating state off state the sensors do not generate significantly changing signals. Now for each sequence of the signal time series of the first flow sensor it is contextualized whether the process group was in in on or in an off state.

In step 790 the contextualized signal time series comprising
the one signal time series per each of one or more measurement points,
the determined least one respective signal time series score for each of the least one measurement points,
the respective plant measurement point information for each of the least one measurement points,
the attributed operation states
is provided.

FIG. 10 illustrates for an illustrative scenario how activity score, volatility score, anomaly score and stationary score may vary dependent on the operating state of the process group. Along the x-Axis operating states of a plant are shown. From left to right the plant is in an off state, this is indicated by a low volatility score and a low activity score. Upon start up of the plant, the volatility score and the activity score show a step like increase. This makes these two scores viable scores to distinguish between on and off states. The stationary score exhibits a more steady evolution over time. However, after a start up phase, when the plant is in normal operating conditions, the stationary score exhibits a relative flat slope. A threshold may be defined to distinguish between stable and instable operating states. Similar to the stationarity during stable operating states the anomaly score exhibits a relatively flat slope. In this illustration a failure state occurs depicted as event. The anomaly score and the stationary score both exhibit a strong fluctuation. After the event, both scores essentially recover, indicating again a stable operating state. During shut down, the stationary score no longer exhibits a stable operating state.

1. A computer implemented method for determining operating states of a chemical plant, in particular of operating states in a process group,
the method comprising:
providing signal time series data associated with a first measurement point in a chemical plant,
determining based on the signal time series data associated with the first measurement point in a chemical plant a respective signal time series score associated with a measure of a degree of variation of the signal time series data over time,
determining the operating state based on the respective signal time series score associated with a measure of a degree of variation of the signal time series data over time,
providing data associated with the operating state of the chemical plant, suitable for monitoring and/or controlling the chemical plant.

2. The method of claim 1, further comprising,
providing signal time series data associated with a second measurement point in a chemical plant,
determining based on the signal time series data associated with the second measurement point respective signal time series score associated with a measure of a degree of variation of the second signal time series data over time,
and wherein determining the operating state comprises determining the operating state based on the respective signal time series scores of the first time series data and the second time series data.

3. The method of claim 2, wherein measurement point information is provided for the first and the second measurement point and wherein the measurement point information comprises a technical relation indicator.

4. The method of claim 3, wherein determining the operating state is further based on the technical relation indicator in particular, the step of determining the operating state comprises determining the operating state based on the respective signal time series score associated with a measure of a degree of variation of the signal time series data over time of the first signal time series data and the second time series data only if the technical relation indicator indicates that the measurement points are technically related, in particular belong to one process group.

5. The method according to claim 1, wherein determining the operating state is based on the respective signal time series score associated with a measure of a degree of variation of the signal time series data over time and a respective cluster classifier.

6. The method according to claim 1, wherein determining the operating state comprises determining an on or an off state.

7. The method according to claim 1, wherein the data associated with the operating state of the chemical plant, suitable for monitoring and/or controlling the chemical plant is indicative of an on state or an off state.

8. The method according to claim 1, further comprising selecting signal time series data associated with an ON-state and determining a stability score on the selected signal time series.

9. The method of claim 8, further comprising determining stable operations based on the stability score.

10. The method of claim 7, further comprising determining an event based on the stability score.

11. The method according to claim 1 comprising providing signal time series data from a measurement point and receiving data associated with the operating state of the chemical plant generated according to claim 1, suitable for monitoring and/or controlling the chemical plant.

12. A system for determining operating states of a chemical plant, the system comprising
an unit time series acquisition unit configured to receive signal time series data associated with a first measurement point in a chemical plant,
an on/off score unit configured to determine based on the signal time series data associated with the first measurement point in a chemical plant a respective signal time series score associated with a measure of a degree of variation of the signal time series data over time
an operating state determining unit configured to determine the operating state based on respective signal time series score associated with a measure of a degree of variation of the signal time series data over time and an output unit configured to provide data associated with the operating state of the chemical plant, suitable for monitoring and/or controlling the chemical plant, the data generated according to claim 1.

13. A computer program product for determining operating states of a chemical plant is disclosed, the computer program product comprising instructions, which, when executed on computing devices of a computing environment, is configured to carry out the steps of the method of determining the operating states of a chemical plant according to claim 1.

14. A computer implemented method for monitoring and/-or controlling a chemical plant, comprising receiving data associated with the operating state of the chemical plant, suitable for monitoring and/or controlling the chemical plant as generated according to claim 1 and providing a control signal based on the received data, in particular when the received data is indicative of an instable operation state, in particular providing a control signal for stopping the plant.

15. A computer implemented method for annotating signal time series data associated with a first measurement point in a chemical plant, comprising receiving data associated with the operating state of the chemical plant, generated according to claim 1, suitable for monitoring and/or controlling the chemical plant as generated according to the method for determining operating states of a chemical plant and storing the data associated with the operating state of the plant together with the signal time series data.
